(19) United States
(12) Patent Application Publication
(10) Pub. No.: US 2025/0102854 A1
(43) Pub. Date: Mar. 27, 2025

(54) OPTICAL SYSTEM AND DISPLAY APPARATUS

(71) Applicant: Beijing Zitiao Network Technology Co., Ltd., Beijing (CN)

(72) Inventors: Xin LI, Beijing (CN); Ling FU, Beijing (CN); Shuai DONG, Beijing (CN); Xiaokai LI, Beijing (CN)

(21) Appl. No.: 18/891,670

(22) Filed: Sep. 20, 2024

(30) Foreign Application Priority Data
Sep. 21, 2023 (CN) 202311227411.X

(51) Int. Cl. G02F 1/1335; G02F 1/13363; G02F 1/137; G06F 3/01

(52) U.S. Cl. CPC G02F 1/133526; G02F 1/133536; G02F 1/133555; G02F 1/13363; G02F 1/13718; G06F 3/011

(57) ABSTRACT

An optical system and a display apparatus are provided. The optical system includes: a lens component, a polarized reflection layer, a transflective film, and a phase retardation film; a distance between two intersection points where the first surface and the second surface intersect with the optical axis is a first distance, a distance between two intersection points where the third surface and the fourth surface intersect with the optical axis is a second distance, and a distance between two intersection points of the fifth surface and the sixth surface intersect with the optical axis is a third distance; a ratio of an absolute value of a curvature radius of the fourth surface to an absolute value of a curvature radius of the third surface is 0.8 to 1, the second distance is greater than the first distance, and the second distance is greater than the third distance.

### CROSS-REFERENCE TO RELATED APPLICATION

The present application claims priority to Chinese Patent Application No. 202311227411.X, filed on Sep. 21, 2023, the disclosure of which is incorporated herein in its entirety as part of the present application.

### TECHNICAL FIELD

At least one embodiment of the present disclosure relates to an optical system and a display apparatus.

### BACKGROUND

With the increasing popularity of Virtual Reality (VR) devices, consumers put forward higher requirements for the lightness, imaging quality and wearing experience of VR devices. With its lightness, excellent imaging quality and mature mass production processes, the pancake architecture has gradually become the development and evolution direction of consumer-grade VR optics.

### SUMMARY

At least one embodiment of the present disclosure provides an optical system, which includes: a lens component, includes at least three lenses, the at least three lenses include a first surface, a second surface, a third surface, a fourth surface, a fifth surface and a sixth surface arranged sequentially along a direction of an optical axis of the lens component, and the fourth surface and the fifth surface having a same surface type parameter; a polarized reflection layer, disposed on a side of the third surface that is away from the fourth surface; a transflective film, disposed on a side of the fourth surface that is away from the third surface; and a phase retardation film, disposed on a side of the transflective film facing the second surface; the second surface is a convex surface, the third surface is a concave surface, the fourth surface is a convex surface, the fifth surface is a concave surface and the sixth surface is a convex surface; a distance between two intersection points where the first surface and the second surface intersect with the optical axis is a first distance, a distance between two intersection points where the third surface and the fourth surface intersect with the optical axis is a second distance, and a distance between two intersection points of the fifth surface and the sixth surface intersect with the optical axis is a third distance; a ratio of an absolute value of a curvature radius of the fourth surface to an absolute value of a curvature radius of the third surface is 0.8 to 1, the second distance is greater than the first distance, and the second distance is greater than the third distance.

For example, according to an embodiment of the present disclosure, a ratio of the absolute value of the curvature radius of the third surface to an effective focal length of the optical system is 2 to 10, a conic constant of the third surface is −50 to 0, a ratio of the absolute value of the curvature radius of the fourth surface to the effective focal length of the optical system is 1.5 to 2.5, and a conic constant of the fourth surface is −10 to 2.

For example, according to an embodiment of the present disclosure, a ratio of the first distance to the effective focal length of the optical system is 0.1 to 0.3; a ratio of the second distance to the effective focal length is 0.4 to 0.7; a ratio of the third distance to the effective focal length is 0.1 to 0.2.

For example, according to an embodiment of the present disclosure, an air gap is provided between the second surface and the third surface.

For example, according to an embodiment of the present disclosure, an absolute value of a size of the air gap in the optical axis is 0.5 mm to 1 mm.

For example, according to an embodiment of the present disclosure, a ratio of an absolute value of a curvature radius of the second surface to the effective focal length of the optical system is 2 to 10, and a conic constant of the second surface is −50 to 0.

For example, according to an embodiment of the present disclosure, at least one selected from the group consisting of the second surface, the third surface and the fourth surface is an aspherical surface or a freeform surface.

For example, according to an embodiment of the present disclosure, the optical system further includes: a linear polarizer film, the linear polarizer film is disposed on a side of the polarized reflection layer that is away from the transflective film.

For example, according to an embodiment of the present disclosure, the linear polarizer film is disposed on one of the first surface, the second surface and the third surface.

For example, according to an embodiment of the present disclosure, the third surface and the fourth surface are two surfaces of a same lens.

For example, according to an embodiment of the present disclosure, the lens component includes a first lens, a second lens, a third lens and a fourth lens arranged along the direction of the optical axis, the first lens includes the first surface and the second surface, the second lens includes the third surface, the third lens includes the fourth surface, the second lens further includes a seventh surface opposite to the third surface, the third lens further includes an eighth surface between the fourth surface and the seventh surface, the fourth lens includes the fifth surface and the sixth surface; the seventh surface and the eighth surface are both flat surfaces, or the seventh surface and the eighth surface have a same surface type parameter, the absolute value of the curvature radius of the third surface and the absolute value of the curvature radius of the fourth surface are both smaller than an absolute value of a curvature radius in at least one direction of the seventh surface; the phase retardation film is located between the seventh surface and the eighth surface.

For example, according to an embodiment of the present disclosure, a distance between two intersection points of the seventh surface and the third surface intersect with the optical axis is a fourth distance, a distance between two intersection points of the eighth surface and the fourth surface intersect with the optical axis is a fifth distance; the fourth distance is smaller than the fifth distance.

For example, according to an embodiment of the present disclosure, a ratio of the first distance to the fourth distance is 1 to 2; a ratio of the third distance to the fourth distance is 0.75 to 1.5; a ratio of the fifth distance to the fourth distance is 1.75 to 3.

For example, according to an embodiment of the present disclosure, the fourth distance is smaller than the first distance, and the fourth distance is smaller than the third distance.

For example, according to an embodiment of the present disclosure, a ratio of the fourth distance to the effective focal length of the optical system is 0.1 to 0.2; a ratio of the fifth distance to the effective focal length is 0.3 to 0.5.

For example, according to an embodiment of the present disclosure, a ratio of a center thickness to an edge thickness of the first lens is greater than 1 and smaller than 3; a ratio of a center thickness to an edge thickness of the second lens is greater than 0.5 and smaller than 1; a ratio of a center thickness to an edge thickness of the third lens is greater than 1 and smaller than 3; a ratio of a center thickness to an edge thickness of the fourth lens is greater than 0.5 and smaller than 1.

For example, according to an embodiment of the present disclosure, an absolute value of a curvature radius in the at least one direction of the seventh surface is 100 millimeters to 200 millimeters.

For example, according to an embodiment of the present disclosure, the second lens, the third lens and the fourth lens are made of a same material, and a material of the first lens is different from the material of the second lens.

For example, according to an embodiment of the present disclosure, the first surface is a flat surface; or the first surface is a curved surface, and a ratio of an absolute value of a curvature radius of the first surface to an effective focal length of the optical system is greater than or equal to 20.

For example, according to an embodiment of the present disclosure, the polarized reflection layer is configured to reflect linearly polarized light of one characteristic and transmit linearly polarized light of another characteristic, the polarized reflection layer is disposed on a side of the third surface that is away from the fourth surface, and the phase retardation film is disposed between the polarized reflection layer and the transflective film; or the polarized reflection layer is a cholesteric liquid crystal layer, the cholesteric liquid crystal layer is disposed on a side of the third surface that is away from the fourth surface, and the phase retardation film is disposed on a side of the cholesteric liquid crystal layer that is away from the transflective film.

At least one embodiment of the present disclosure provides a display apparatus, which includes a display screen and the optical system described in any of the above embodiments, the display screen is located on a side of the sixth surface that is away from the first surface.

### BRIEF DESCRIPTION OF DRAWINGS

In order to more clearly illustrate the technical solutions of the embodiments of the present disclosure, the accompanying drawings of the embodiments will be briefly introduced below, it is obvious that the accompanying drawings in the following description merely relate to some embodiments of the present disclosure, but not the limitations of the present disclosure.

FIG. 1 is a cross-sectional view of an optical system provided according to an example of an embodiment of the present disclosure.

FIG. 2 is a cross-sectional view of an optical system provided according to another example of an embodiment of the present disclosure.

FIG. 3 is a cross-sectional view of an optical system provided according to yet another example of an embodiment of the present disclosure.

FIG. 4 to FIG. 7 are cross-sectional views of optical systems provided according to different examples of embodiments of the present disclosure.

FIG. 8A is a spot diagram of the optical system shown in FIG. 4.

FIG. 8B is a curve chart of a diffuse spot size of the optical system shown in FIG. 4 changing with field of view.

FIG. 8C is a distortion diagram of the optical system shown in FIG. 4.

FIG. 8D is a lateral chromatic aberration diagram of the optical system shown in FIG. 4.

FIG. 9 is a partial cross-sectional view of a display apparatus provided by an example of an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

The features “perpendicular”, “parallel” and “same” used in the embodiments of the present disclosure all include features such as “parallel”, “perpendicular” and “same” in the strict sense, and the cases having certain errors, such as “approximately parallel”, “approximately perpendicular”, “substantially the same” or the like, taking into account measurements and errors associated with the measurement of a particular quantity (That is, limitations of the measurement system), and indicate being within an acceptable range of deviation for a particular value as determined by one of ordinary skill in the art. The feature “center” in the embodiments of the present disclosure may include the position strictly located at the geometric center and the approximately central position within a small area around the geometric center. For example, “approximately” may indicate being within one or more standard deviations, or within 10% or 5% of the stated value.

Some head-mounted display devices using VR technology, such as VR glasses, can block a person's visual and auditory perception of the external world, guiding users to experience a sensation of being immersed in a virtual environment. The display principle of VR glasses is that the left-eye screen and the right-eye screen display the images of the left eye and the right eye respectively, and a human eye will have a stereoscopic impression in its mind after obtaining this information with differences. In order to improve the comfort during wearing, it is often necessary to take into account the requirements of imaging clarity, field of view, distortion, chromatic aberration and other optical parameters.

At least one embodiment of the present disclosure provides an optical system, including a lens component, a polarized reflection layer, a transflective film and a phase retardation film. The lens component includes at least three lenses, the at least three lenses include a first surface, a second surface, a third surface, a fourth surface, a fifth surface and a sixth surface arranged sequentially along a direction of an optical axis of the lens component, and the fourth surface and the fifth surface have a same surface type parameter; the polarized reflection layer is disposed on a side of the third surface that is away from the fourth surface; the transflective film is disposed on a side of the fourth surface that is away from the third surface; the phase retardation film is disposed on a side of the transflective film facing the second surface; the second surface is a convex surface, the third surface is a concave surface, the fourth surface is a convex surface, the fifth surface is a concave surface and the sixth surface is a convex surface; a distance between two intersection points where the first surface and the second surface intersect with the optical axis is a first distance, a distance between two intersection points where the third surface and the fourth surface intersect with the optical axis is a second distance, and a distance between two intersection points of the fifth surface and the sixth surface intersect with the optical axis is a third distance; and a ratio of an absolute value of a curvature radius of the fourth surface to an absolute value of a curvature radius of the third surface is 0.8 to 1, the second distance is greater than the first distance, and the second distance is greater than the third distance.

At least one embodiment of the present disclosure provides a display apparatus, including a display screen and the optical system as described in any of the above embodiments, and the display screen is located on a side of the sixth surface that is away from the first surface.

In the optical system and the display apparatus provided by at least one embodiment of the present disclosure, the lens component is set with at least three lenses, more attachment positions are provided for the polarized reflection layer, the transflective film and the phase retardation film, so that the degree of freedom in the design of surface type parameters of the optical system can be improved while achieving light retroreflection by the polarized reflection layer and the transflective film. Moreover, by setting the relationship between the radii of curvature of the third surface and the fourth surface, and setting the distance relationship between the surfaces, the clarity of the optical system can be enhanced.

The optical system and the display apparatus are described below with reference to the drawings and through some embodiments.

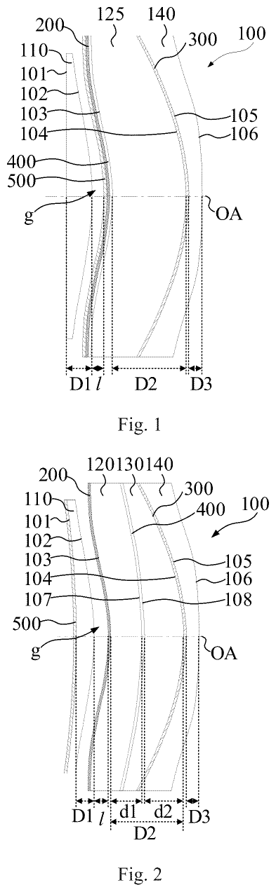

FIG. 1 is a cross-sectional view of an optical system according to an example of embodiments of the present disclosure.

Referring to FIG. 1, at least one embodiment of the present disclosure provides an optical system including a lens component 100. The lens component 100 includes at least three lenses. For example, as shown in FIG. 1, the lens component 100 may be composed of a lens 110, a lens 125 and a lens 140.

As shown in FIG. 1, the at least three lenses include a first surface 101, a second surface 102, a third surface 103, a fourth surface 104, a fifth surface 105 and a sixth surface 106 which are sequentially arranged in a direction of an optical axis OA of the lens component 100. The fourth surface 104 and the fifth surface 105 have a same surface type parameter. For example, the fourth surface 104 and the fifth surface 105 having the same surface type parameter means that the second surface 102 may almost completely be attached to the third surface 103 without considering presence of other film layers between the two.

As shown in FIG. 1, the polarized reflection layer 200 is disposed on a side of the third surface 103 that is away from the fourth surface 104, the transflective film 300 is disposed on a side of the fourth surface 104 that is away from the third surface 103, and the phase retardation film 400 is disposed on a side of the transflective film 300 facing the second surface 102. For example, light incident on the lens component 100 after being transmitted by the transflective film 300 is configured to be folded back between the transflective film 300 and the polarized reflection layer 200 and emitted from the polarized reflection layer 200, thereby forming a folded optical path through the polarized reflection layer 200, the transflective film 300 and the phase retardation film 400.

As shown in FIG. 1, the second surface 102 is a convex surface, the third surface 103 is a concave surface, the fourth surface 104 is a convex surface, the fifth surface 105 is a concave surface and the sixth surface 106 is a convex surface. For example, a side of the first surface 101 that is away from the sixth surface 106 is a light emitting side of the optical system. For example, when the optical system is applied to a display apparatus, a display screen is located on a side of the sixth surface 106 of the optical system that is away from the first surface 101, and light emitted by the display screen incident on the sixth surface 106 and exits from the first surface 101. While achieving light folding back by the polarized reflection layer 200 and the transflective film 300, the multiple lenses in the lens component 100 are favorable for improving the degree of freedom in the design of the surface type parameters of the optical system.

As shown in FIG. 1, a distance between two intersection points of the first surface 101 and the second surface 102 intersect with the optical axis OA is a first distance D1, a distance between two intersection points of the third surface 103 and the fourth surface 104 intersect with the optical axis OA is a second distance D2, and a distance between two intersection points of the fifth surface 105 and the sixth surface 106 intersect with the optical axis OA is a third distance D3. For example, without considering film layer thicknesses, the distance between two intersection points of the third surface 103 and the fourth surface 104 with the optical axis OA is a distance between the polarized reflection layer 200 and the phase retardation film 400.

As shown in FIG. 1, a ratio of an absolute value of a curvature radius of the fourth surface 104 to an absolute value of a curvature radius of the third surface 103 is 0.8 to 1. For example, the ratio of the absolute value of the curvature radius of the fourth surface 104 to the absolute value of the curvature radius of the third surface 103 may be, but is not limited thereto, 0.8, 0.85, 0.9, 0.95, 1. As shown in FIG. 1, the second distance D2 is greater than the first distance D1, and the second distance D2 is greater than the third distance D3. It can be understood that among the first distance D1, the second distance D2 and the third distance D3, the distance between two intersection points of the third surface 103 and the fourth surface 104 intersect with the optical axis OA is the largest. By setting the distance between the polarized reflection layer 200 and the phase retardation film 400 and the relationship between the curvature radii of the surfaces where the two film layers are located, the focal power of the whole optical system can be evenly distributed, enabling the optical system to achieve high resolution and better clarity.

For example, referring to FIG. 1, the polarized reflection layer 200 has functions as follows: the film layer plane has a transmission axis direction, and incident light has transmittance of a polarization component parallel to the transmission axis direction (e.g., s-linearly polarized light) greater than transmittance of a polarization component perpendicular to the transmission axis direction (e.g., p-linearly polarized light), and reflectance of the polarization component parallel to the transmission axis direction (e.g., s-linearly polarized light) less than reflectance of the polarization component perpendicular to the transmission axis direction (e.g., p-linearly polarized light). For example, transmittance of polarized light parallel to the transmission axis direction of the reflective polarization layer 300 is no less than 85%, for example, no less than 90%, for example, no less than 95%, for example, no less than 98%; and reflectance of polarized light perpendicular to the transmission axis direction of the polarized reflection layer 200 is no less than 85%, for example, no less than 90%, for example, no less than 95%, for example, no less than 98%.

For example, referring to FIG. 1, the transflective film 300 is configured to transmit a portion of light and reflect another portion of light. For example, the transflective film 300 may have transmittance of 50%, and reflectance of 50%. For example, the transflective film 300 may have transmittance of 60%, and reflectance of 40%. For example, the transflective film 300 may have transmittance of 65%, and reflectance of 35%. The optical system provided by the present disclosure is not limited thereto; and transmittance and reflectance of the transflective film may be set according to product requirements. For example, the transflective film 300 may be plated on the fourth surface 104.

For example, referring to FIG. 1, the phase retardation film 400 is configured to cause the transmitted light to implement transition between a circularly polarized state and a linearly polarized state. For example, the phase retardation film 400 may be a ¼ wave plate. For example, the phase retardation film 400 has characteristics below: the film layer plane has a direction with the lowest refractive index and a direction with the highest refractive index, which are respectively a fast axis and a slow axis; polarized light parallel to the slow axis is delayed by ¼ wavelength after passing through the phase retardation film 400 as compared with polarized light parallel to the fast axis. For example, an included angle between the slow axis of the phase retardation film 400 and a transmission axis of the polarized reflection layer 200 is 45 degrees.

For example, referring to FIG. 1, the material of the phase retardation film 400 may include liquid crystal polymers. Because the phase retardation film 400 made of the liquid crystal polymer material is a polymer, its film thickness is relatively thinner, which may reach 1 μm to 5 μm. The thinner phase retardation film 400 has a higher degree of adaptation to curved surfaces and can be more easily shaped according to the surface type of the curved surface, reducing the possibility of wrinkles when adhering to the curved surface and affecting the phase retardation accuracy and optical performance. Moreover, the phase retardation film 400 made of the liquid crystal polymer material has less optical offset after being attached to a curved surface. The liquid crystal polymer is a cross-linked system, with molecules connected by chemical bonds with high modulus. When the phase retardation film 400 is subjected to tension after attaching, it has only elastic deformation, without intense effects such as molecular extension and rearrangement that affect optical anisotropy. Therefore, the phase retardation film 400 made of the liquid crystal polymer material is suitable for attaching to surfaces with small curvature radii. Such a degree of freedom of curvature radius is also easier to meet the index requirements for clarity, distortion, dispersion, which is conducive to obtaining better image quality for the optical system.

For example, referring to FIG. 1, the folded optical path has a principle as follows: a wave plate may be provided on an emergent side of a display surface of the display screen that is located on a side of the sixth surface 106 that is away from the first surface 101, image light emitted from the display surface 11 is converted into right-handed circularly polarized light after passing through the wave plate, and the right-handed circularly polarized light keeps a polarized state unchanged after being transmitted by the transflective film 300. The right-handed circularly polarized light incident on the lens component 100 and reaches the phase retardation film 400 after being transmitted by the lens component 100; The right-handed circularly polarized light incident on the phase retardation film 400 is converted into p-linearly polarized light; the p-linearly polarized light is reflected back by the polarized reflection layer 200 to the phase retardation film 400, where a first reflection occurs. Afterwards, the p-linearly polarized light is converted into right-handed circularly polarized light after passing through the phase retardation film 400; the right-handed circularly polarized light reaches the transflective film 300 after being transmitted through the lens component 100, and is reflected at the transflective film 300, where the second reflection occurs. Because of half wave loss, the reflected light changes from right-handed circularly polarized light to left-handed circularly polarized light. The left-handed circularly polarized light reaches the phase retardation film 400 after being transmitted through the lens component 100, and is transformed into s-linearly polarized light after being transmitted through the phase retardation film 400, and then the s-linearly polarized light is transmitted through the polarized reflection layer 200 and emitted to an exit pupil, such as the human eye.

The above-described folded optical path may change a polarized state of light propagating between the polarized reflection layer 200 and the transflective film 300, implementing folding of a light path, so that an original focal length of the optical system is folded because of, for example, two reflections added by providing the polarized reflection layer 200, the phase retardation film 400, and the transflective film 300 as described above, which greatly compresses space required between the human eye and the optical system, resulting in a smaller and lighter volume of the optical system.

Referring to FIG. 1, in some examples, the first surface 101 is a flat surface. The flat first surface 101 can provide a relatively flat surface for the attachment of film layers. For example, a side of the first surface 101 that is away from the second surface 102 may be provided with an antireflection film. For example, a side of the second surface 102 that is away from the first surface 101 may also be provided with an antireflection film. For example, a side of the sixth surface 106 that is away from the first surface 101 may also be provided with an antireflection film. For example, antireflection films help reduce stray light caused by reflections.

FIG. 2 is a cross-sectional view of an optical system according to another example of embodiments of the present disclosure. The optical system shown in FIG. 2 differs from the optical system shown in FIG. 1 in that the first surface in the optical system shown in FIG. 2 differs from the first surface in the optical system shown in FIG. 1 in surface type. For example, the first surface in the optical system shown in FIG. 2 is a curved surface. Of course, there may be other differences between the optical system shown in FIG. 2 and the optical system shown in FIG. 1, such as the number of lenses in the lens component, the positional relationship between the film layers, etc., which is not limited by the present disclosure.

It should be noted that the lens component in the optical system shown in FIG. 2 may be different from or the same as the lens component in the optical system shown in FIG. 1. The polarized reflection layer 200, the transflective film 300 and the phase retardation film 400 in the optical system shown in FIG. 2 may have the same characteristics as the polarized reflection layer 200, the transflective film 300 and the phase retardation film 400 in the optical system shown in FIG. 1, which will not be repeated here. In combination with some examples described later, the linear polarizer film 500 in FIG. 2 may also have the same characteristics as the linear polarizer film 500 in the optical system shown in FIG. 1.

Referring to FIG. 2, in some examples, the first surface 101 is a curved surface, and a ratio of an absolute value of a curvature radius of the first surface 101 to an effective focal length is greater than or equal to 10. The effective focal length refers to a distance from a rear principal image plane to a paraxial image plane. The effective focal length is, for example, an effective focal length after coating the surfaces of each lens of the lens component 100. For example, the first surface 101 may be either a concave surface as shown in FIG. 2, or a convex surface. For example, the ratio of the curvature radius of the first surface 101 to the effective focal length is −20, −21, −22, −23, −24, −25. For example, the ratio of the curvature radius of the first surface 101 to the effective focal length is 10, 15, 20, 25, 30. It is understandable that the variation range of the curvature radius of the first surface 101 is relatively large. For example, when the first surface 101 and the second surface 102 are two opposite surfaces of one lens, as long as the entire lens can be ensured to have a positive focal power, it is sufficient.

Referring to FIG. 1, in some examples, a ratio of an absolute value of a curvature radius of the second surface 102 to the effective focal length is 2 to 10. For example, the ratio of the curvature radius of the second surface 102 to the effective focal length is −10 to −2. For example, the ratio of the curvature radius of the second surface 102 to the effective focal length may be, but is not limited thereto, −10, −9, −8, −7, −6, −5, −4, −3, −2. For example, a conic constant of the third surface 103 may be, but is not limited thereto, −50, −45, −40, −35, −30, −25, −20, −15, −10, −5, −1, 0.

Referring to FIG. 1, in some examples, a ratio of an absolute value of a curvature radius of the third surface 103 to the effective focal length of the optical system is 2 to 10, and a conic constant of the third surface 103 is −50 to 0. For example, the ratio of the curvature radius of the third surface 103 to the effective focal length is −10 to −2. For example, the ratio of the curvature radius of the third surface 103 to the effective focal length may be, but is not limited thereto, −10, −9, −8, −7, −6, −5, −4, −3, −2. For example, the conic constant of the third surface 103 may be, but is not limited thereto, −50, −45, −40, −35, −30, −25, −20, −15, −10, −5, −1, 0. For example, the curvature radius of the third surface 103 is relatively close to the curvature radius of the second surface 102.

Referring to FIG. 1, in some examples, a ratio of an absolute value of a curvature radius of the fourth surface 104 to the effective focal length of the optical system is 1.5 to 2.5, and a conic constant of the fourth surface 104 is −10 to −2. For example, the ratio of the curvature radius of the fourth surface 104 to the effective focal length of the optical system is −1.5 to −2.5. For example, the ratio of the curvature radius of the fourth surface 104 to the effective focal length of the optical system may be, but is not limited thereto, −1.5, −1.75, −2, −2.25, −2.5. For example, the conic constant of the fourth surface 104 may be, but is not limited thereto, −10, −9, −8, −7, −6, −5, −4, −3, −2.

For example, FIG. 1 schematically shows the influence of each film layer on the distance between different surfaces of the lens component 100. For example, when the thickness of each film layer is relatively thin, the thickness of the film layer thickness may be ignored.

Referring to FIG. 1, in some examples, a ratio of the first distance D1 to the effective focal length is 0.1 to 0.3. For example, the ratio of the first distance D1 to the effective focal length may be, but is not limited thereto, 0.1, 0.15, 0.2, 0.25, 0.3. For example, the first surface 101 and the second surface 102 are two opposite surfaces of one lens 110, and the first distance D1 is a center thickness of the lens 110.

Referring to FIG. 1, in some examples, a ratio of the second distance D2 to the effective focal length is 0.4 to 0.7. For example, the ratio of the second distance D2 to the effective focal length may be, but is not limited thereto, 0.4, 0.45, 0.5, 0.55, 0.6, 0.65, 0.7. Referring to FIG. 1, in some examples, the third surface 103 and the fourth surface 104 are two surfaces of a same lens. For example, the third surface 103 and the fourth surface 104 are two opposite surfaces of an integrated lens 125 as shown in FIG. 1, and the second distance D2 is a center thickness of the lens 125. For example, the integrated lens may be a single lens. For example, the third surface 103 and the fourth surface 104 are on two lenses (such as lens 120 and lens 130) respectively as shown in FIG. 2.

Referring to FIG. 1, in some examples, a ratio of the third distance D3 to the effective focal length is 0.1 to 0.2. For example, the ratio of the third distance D3 to the effective focal length may be, but is not limited thereto, 0.1, 0.11, 0.12, 0.13, 0.14, 0.15, 0.16, 0.17, 0.18, 0.19, 0.2. For example, the fifth surface 105 and the sixth surface 106 are two opposite surfaces of a lens 140 as shown in FIG. 1, and the third distance D3 is a center thickness of the lens 140.

Referring to FIG. 1, in some examples, at least one selected from the group consisting of the second surface 102, the third surface 103 and the fourth surface 104 is an aspherical surface or a freeform surface. For example, the second surface 102, the third surface 103 and the fourth surface 104 are all aspherical surfaces or freeform surfaces. The aspherical surface may be even aspheric surface (EVENASPH), and a curvature radius of the aspherical surface is a curvature radius of a base spherical surface on a surface thereof. The above-described “base spherical surface” refers to a spherical surface serving as a basis for further deformation to form an aspherical surface, and thus, the spherical surface is just the base spherical surface of the aspherical surface. The freeform surface is, for example, a complex unconventional continuous surface without rotational symmetry axis.

For example, a surface type of the aspherical surface is represented by a numerical formula below:

$$z = \frac{C {Y}^{2}}{1 + \sqrt{1 - ( 1 + k ) {C}^{2} {Y}^{2}}} + {Σ}_{i = 2}^{N} {α}_{i} {Y}^{2 i} .$$

For example, in the above-described formula, the height of the aspherical surface along a direction perpendicular to the optical axis is Y, and a distance between a vertex of the aspherical surface and a projection of a position whose height is Y in the aspherical surface in the optical axis is z, that is, z is a coordinate along the direction of the optical axis; C is a curvature (a reciprocal of the curvature radius R), k is a conic constant, αᵢ is a coefficient of each higher-order term, and 2i is the order of aspherical coefficient.

When optimizing rational configuration of the surface type parameter of the lens component in practice, values such as the curvature radius, the conic constant, the height, and the aspherical coefficient of each lens of the lens component are put into the above-described numerical formula, so that respective optimization parameters that may correct aberrations of each lens of the lens component are obtained through optical simulation calculation. Optimal values of curvature radius, thickness along the optical axis, effective aperture and conic constant of each lens in the lens component are obtained through the optimization process.

In combination with the foregoing examples, for example, the higher-order coefficient of the second surface 102 satisfies: α₄=−1.0E−05, α₆=3.0E−08, α₈=2.7E−11, and α₁₀=−2.0E−13. For example, the higher-order coefficient of the third surface 103 satisfies: α₄=8.0E−06, α₆=−1.7E−08, α₈=6.0E−11, and α₁₀=−6.0E−14. For example, the higher-order coefficient of the fourth surface 104 satisfies: α₄=−4.0E−07, α₆=−4.0E−10, α₈=−1.5E−12, and α₁₀=2.0E−14. For example, the higher-order coefficient of the fifth surface 105 are exactly the same as the higher-order coefficient of the fourth surface 104. For example, the higher-order coefficient of the sixth surface 106 satisfies: α₄=−6.0E−05, α₆=−6.0E−07, α₈=2.0E−08, and α₁₀=−3.0E−10.

Referring to FIG. 1, in some examples, an air gap g is provided between the second surface 102 and the third surface 103. The third surface 103 and the air gap g can deflect the light, and the air gap g and the second surface 102 can deflect the light, so that a large field of view can be achieved on a small screen. Moreover, the air gap g allows the second surface 102 and the third surface 103 to have different surface types, thus improving the degree of freedom in the design of the optical system and being favorable for correcting aberration, especially chromatic aberration, thereby facilitating the optical system to achieve high resolution. In addition, as shown in FIG. 1, the air gap g is provided between the second surface 102 and the third surface 103 only, which also minimizes ghost images as much as possible. In other embodiments, an air gap g may also be provided between other two adjacent surfaces, which is not limited by the present disclosure. For example, an air gap g exists between the second surface 102 and the third surface 103, that is, the lens 110 where the second surface 102 is located and the lens 125 where the third surface 103 is located are completely separated. During assembly and adjustment, two lenses (for example, the lens 110 and the lens 125) may be fixed by an edge lens barrel, thus ensuring that the lenses in the lens component 100 are coaxial.

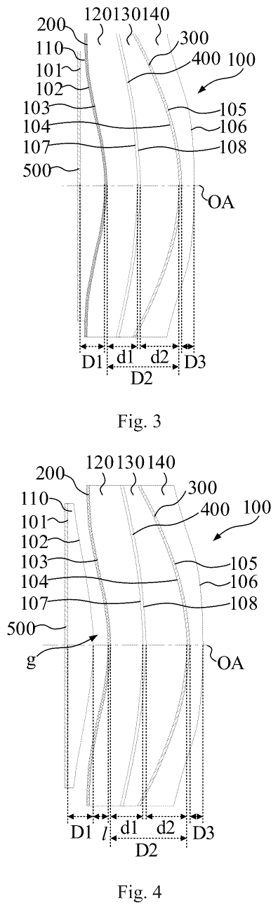

FIG. 3 is a cross-sectional view of an optical system according to yet another example of embodiments of the present disclosure. The optical system shown in FIG. 3 differs from the optical system shown in FIG. 1 in that no air gap is disposed between the first lens and the second lens in the optical system shown in FIG. 3. Of course, there may be other differences between the optical system shown in FIG. 3 and the optical system shown in FIG. 1, such as the number of lenses in the lens component, the surface type of each lens, the positional relationship between the film layers, etc., which is not limited by the present disclosure.

It should be noted that the lens component in the optical system shown in FIG. 3 may be different from or the same as the lens component in the optical system shown in FIG. 1. The polarized reflection layer 200, the transflective film 300 and the phase retardation film 400 in the optical system shown in FIG. 3 may have the same characteristics as the polarized reflection layer 200, the transflective film 300 and the phase retardation film 400 in the optical system shown in FIG. 1, which will not be repeated here. In combination with some examples described later, the linearly polarized film 500 in FIG. 3 may also have the same characteristics as the linearly polarized film 500 in the optical system shown in FIG. 1.

For example, referring to FIG. 3, the second surface 102 and the third surface 103 may also have a same surface type parameter, and the second surface 102 is bonded to the third surface 103, thereby improving the compactness of the optical system while alleviating a ghost problem.

Referring to FIG. 1, in some examples, an absolute value of a size l of the air gap g in the optical axis OA is 0.5 mm to 1 mm. For example, the absolute value of the size l of the air gap g in the optical axis OA may be, but is not limited thereto, 0.5 mm, 0.55 mm, 0.6 mm, 0.65 mm, 0.7 mm, 0.75 mm, 0.8 mm, 0.85 mm, 0.9 mm, 0.95 mm and 1 mm. For example, by setting the size of the air gap g, it can not only ensure that the two surfaces will not make contact after coating, but also be favorable for the assembly and adjustment of the optical system. In addition, the size l of the air gap g in the optical axis OA may also reduce an overall length of the optical system as much as possible, making the optical system more compact. It can be understood that a shape of the air gap g is mainly determined by the surface types of the second surface 102 and the third surface 103 on its two opposite sides along the direction of the optical axis OA, which is not limited by the present disclosure.

Referring to FIG. 1, in some examples, the optical system further includes a linear polarizer film 500, and the linear polarizer film 500 is disposed on a side of the polarized reflection layer 200 that is away from the transflective film 300. For example, the linear polarizer film 500 may be a linear polarizer sheet or a polarizer device. For example, a transmission axis of the linear polarizer film 500 coincides with the transmission axis of the polarized reflection layer 200. For example, the linear polarizer film 500 may be further used for filtering out other stray light, allowing only polarized light (e.g., s-linearly polarized light) to pass through the linear polarization film 500 and enter the human eye. For example, the linear polarization film 500 may adopt a three-layer structure, a middle layer in the three-layer structure may be made of polyvinyl alcohol (PVA) added with dichroic molecules, at least one layer on both sides of the middle layer in the three-layer structure may be made of triacetate cellulose (TAC). For example, a surface of the linear polarization film 500 that faces the air is subjected to anti-reflection treatment. For example, the surface of the linear polarization film 500 that faces the air may be attached to a moth eye film.

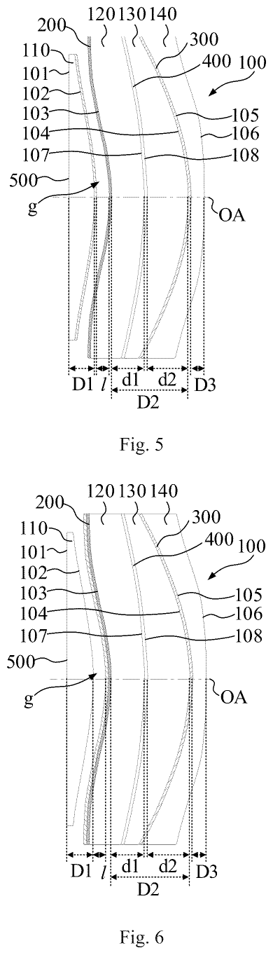

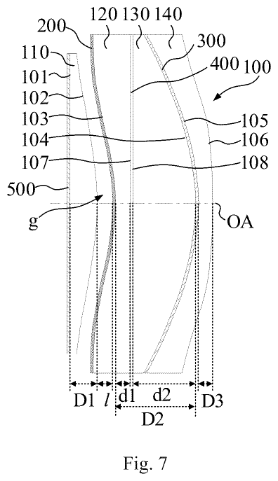

FIG. 4 to FIG. 7 are cross-sectional views of optical systems provided by different examples according to the embodiments of the present disclosure. The optical system shown in FIG. 4 differs from that shown in FIG. 1 in that the positional relationship between the film layers in the optical system shown in FIG. 4 differs from the positional relationship between the film layers in the optical system shown in FIG. 1. For example, a position of the linear polarizer film in FIG. 4 differs from a position of the linear polarizer film in FIG. 1. In addition, the optical system shown in FIG. 5 and the optical system shown in FIG. 6 both show different positions of the linear polarizer film compared to the optical system shown in FIG. 4. The optical system shown in FIG. 7 differs from the optical system shown in FIG. 6 in that surface types of the seventh surface and the eighth surface in the optical system shown in FIG. 7 are different from surface types of the seventh surface and the eighth surface in the optical system shown in FIG. 6. For example, the seventh surface and the eighth surface in FIG. 7 are flat surfaces, and the seventh surface and the eighth surface in FIG. 6 are curved surfaces.

Of course, there may be other differences between the optical systems shown in FIG. 4 to FIG. 7 and the optical system shown in FIG. 1, such as the number of lenses in the lens component, the surface type of each lens, the positional relationship between the film layers, etc., which is not limited by the present disclosure.

It should be noted that the lens component in the optical systems shown in FIG. 4 to FIG. 7 may be different from or the same as the lens component in the optical system shown in FIG. 1. The polarized reflection layer 200, the transflective film 300, the phase retardation film 400 and the linear polarizer film 500 in the optical systems shown in FIG. 4 to FIG. 7 may have the same characteristics as the phase retardation film 400 and the linear polarizer film 500 in the optical system shown in FIG. 1, which will not be repeated here.

Referring to FIG. 2 to FIG. 4, in some examples, the linear polarizer film 500 is disposed on the first surface 101. In combination with the foregoing examples, since the first surface 101 is a flat surface or a micro-curvature surfaces with a large curvature radius, a relatively flat attachment surface may be provided for the linear polarizer film 500, and the risk of wrinkles of the linear polarizer film 500 after attachment may be reduced.

Referring to FIG. 5, in some examples, the linear polarizer film 500 is disposed on the second surface 102. It can be understood that the first surface 101 and the second surface 102 are, for example, two surfaces of one lens 110. The first surface 101 or the second surface 102 may provide a separate attachment position for the linear polarizer film 500, that is, when attaching the linear polarizer film 500, there is no need to consider the possible influence with other film layers (such as the polarized reflection layer 200 or the phase retardation film 400). Moreover, the process of attaching the linear polarizer film 500 is easier to realize, and wrinkles are not generated easily.

Referring to FIG. 1 and FIG. 6, in some examples, the linear polarizer film 500 is disposed on the third surface 103. In this way, the linear polarizer film 500 may completely cover other film layers, thereby enabling the linear polarizing film 500 to have a better filtering effect on stray light.

Referring to FIG. 4 to FIG. 6, in some examples, the lens component 100 includes a first lens 110, a second lens 120, a third lens 130 and a fourth lens 140 arranged along a direction of an optical axis OA. The first lens 110 includes a first surface 101 and a second surface 102. The second lens 120 includes a third surface 103. The third lens 130 includes a fourth surface 104. The second lens 120 further includes a seventh surface 107 opposite to the third surface 103, the third lens 130 further includes an eighth surface 108 located between the fourth surface 104 and the seventh surface 107, and the fourth lens 140 includes a fifth surface 105 and a sixth surface 106. It can be understood that the third surface 103 and the seventh surface 107 are two opposite surfaces of the second lens 120, and the fourth surface 104 and the eighth surface 108 are two opposite surfaces of the third lens 130. For example, before the image light emitting from the display surface 11 is incident on the lens component 100, the image light is subjected to refraction through an air-medium interface once, after emitting from the polarized reflection layer 200 and passing through the air gap g between the first lens 110 and the second lens 120, and then emits from the first lens 110 and is refracted through an air-medium interface. In this way, it is favorable for deflecting light, achieving the experience of a large field of view on a smaller screen size.

In some examples, the phase retardation film 400 is located between the seventh surface 107 and the eighth surface 108. In this way, additional attachment surfaces are provided for the phase retardation film 400 through the seventh surface 107 and the eighth surface 108.

Referring to FIG. 6, in some examples, the seventh surface 107 and the eighth surface 108 have a same surface type parameter, and an absolute value of the curvature radius of the third surface 103 and an absolute value of the curvature radius of the fourth surface 104 are both smaller than an absolute value of the curvature radius of the seventh surface 107 in at least one direction. By making the seventh surface 107 and the eighth surface 108 into curved surfaces, the center thickness and the edge thickness of the second lens 120 and the center thickness and the edge thickness of the third lens 130 may be easily adjusted, and the processing difficulty is reduced. For example, the seventh surface 107 and the eighth surface 108 both bend towards the side away from the first surface 101, so that a difference between the center thickness and the edge thickness of the second lens 120 is small, and a difference between the center thickness and the edge thickness of the third lens 130 is small. For example, without considering film layers provided between the seventh surface 107 and the eighth surface 108, the seventh surface 107 may almost completely be attached to the eighth surface 108.

Referring to FIG. 6, in some examples, an absolute value of the curvature radius in the at least one direction of the seventh surface 107 is 100 millimeters to 200 millimeters. For example, an absolute value of the curvature radius in the at least one direction of the eighth surface 108 is also 100 millimeters to 200 millimeters. For example, an absolute value of a curvature radius in any direction of the seventh surface is 100 millimeters to 200 millimeters. For example, an absolute value of a curvature radius in any direction of the eighth surface is 100 millimeters to 200 millimeters. The radii of curvature of the seventh surface 107 and the eighth surface 108 are set to be large, that is, the seventh surface 107 and the eighth surface 108 are constructed as micro-curvature surfaces that approach planarity. For example, the seventh surface 107 and the eighth surface 108 are spherical surfaces.

For example, when the seventh surface 107 and the eighth surface 108 are curved surfaces, taking the attachment of the phase retardation film 400 to the seventh surface 107 as an example for illustration. In the process of attaching the phase retardation film 400 to the lens component 100, the flat-shaped phase retardation film 400 firstly needs to be stretched appropriately, and then completely attached to the curved seventh surface 107. In the case where the curvature radius of the seventh surface 107 of the lens component 100 is relatively small, for example, when the absolute value thereof is less than 100 millimeters and meanwhile the conic constant is greater than or equal to zero, the phase retardation film 400 may produce wrinkles when stretched and attached to the seventh surface 107; the wrinkles produced by excessively stretching and attaching the phase retardation film 400 may affect accuracy of phase delay of the phase retardation film, and further affect optical performance. In the optical system provided by the present disclosure, by setting the absolute value of the curvature radius of the seventh surface 107 or the eighth surface 108 for attaching the phase retardation film 400 greater, impact of the curved surface type of the seventh surface 107 or the eighth surface 108 on the performance of the phase retardation film 400 may be reduced.

For example, the seventh surface 107 may be a curved surface having a rotational symmetry characteristic. The curved surface having a rotational symmetry characteristic refers to a curved surface formed when a curve rotates around a straight line by a circle. The plane curve is the generatrix of the rotating surface, and the straight line is the rotation axis of the rotating surface. The curved surface having a rotational symmetry characteristic has the same curvature radius and the same conic constant in different directions.

For example, the seventh surface 107 may be a curved surface having an axial symmetry characteristic. The curved surface having an axial symmetry characteristic refers to that the curved surface is symmetrical about a symmetry axis, for example, the curved surface has different radii of curvature or conic constants in different directions. For example, a curved surface having an axial symmetry may be a cylindrical surface, which refers to a curved surface formed by the parallel movement of a straight line along a fixed curve. When a curved surface is a cylindrical surface, it is a curved surface in one direction and a flat surface in another direction.

By setting the shape of the seventh surface 107 as described above, a better attachment surface type is provided for the phase retardation film 400, which is favorable for preventing the type of the phase retardation film 400 from being greatly influenced in the process of stretching and attaching the phase retardation film 400.

Referring to FIG. 7, in some examples, the seventh surface 107 and the eighth surface 108 are both flat surfaces. The phase retardation film 400 includes a birefringent material. The phase retardation film 400 is attached to the seventh surface 107 or the eighth surface 108 having a planar shape, which may improve the flatness of the film material, overcome process challenges caused by curved attaching, and avoid a softening and stretching process of the above-described film material which affects birefringence properties such as optical axis angle and phase delay, so it is easy to maintain fixed phase delay, and is favorable for improving overall optical performance of the optical system, such as clarity, stray light, and field of view, to ensure imaging quality.

Referring to FIG. 7, in some examples, a distance between two intersection points of the seventh surface 107 and the third surface 103 intersect with the optical axis OA is a fourth distance d1, a distance between two intersection points of the eighth surface 108 and the fourth surface 104 intersect with the optical axis OA is a fifth distance d2, and the fourth distance d1 is smaller than the fifth distance d2. For example, the fourth distance d1 is the center thickness of the second lens 120. For example, the second lens 120 may be a negative lens. For example, the second lens 120 may be a planoconcave lens. For example, the fifth distance d2 is the center thickness of the third lens 130. For example, the third lens 130 may be a positive lens. For example, the third lens 130 may be a planoconvex lens. For example, in the case where the thicknesses of the respective film layers are relatively thin, the thicknesses of the film layer may be ignored; and at this time, a sum of the center thickness of the second lens 120 and the center thickness of the third lens 130 may be the above-described second distance D2, for example, a sum of the fourth distance d1 and the fifth distance d2 is the second distance D2.

Referring to FIG. 1 to FIG. 7, in some examples, a ratio of the first distance D1 to the fourth distance d1 is 1 to 2. For example, the ratio of the first distance D1 to the fourth distance d1 is 1, 1.1, 1.2, 1.3, 1.4, 1.5, 1.6, 1.7, 1.8, 1.9, 2. In some examples, a ratio of the third distance D3 to the fourth distance d1 is 0.75 to 1.5. For example, the ratio of the third distance D3 to the fourth distance d1 is 0.75, 0.8, 0.85, 0.9, 0.95, 1, 1.05, 1.1, 1.2, 1.3, 1.4, 1.5. In some examples, a ratio of the fifth distance d2 to the fourth distance d1 is 1.75 to 3. For example, the ratio of the fifth distance d2 to the fourth distance d1 is 1.75, 2, 2.25, 2.5, 2.75, 3. For example, the ratio of the first distance D1 to the fourth distance d1 to the fifth distance d2 to the third distance D3 is (2 to 4):2:(3.5 to 6):(1.5 to 3). For example, the ratio of the first distance D1 to the fourth distance d1 to the fifth distance d2 to the third distance D3 is 3:2:5:2.

Referring to FIG. 1 to FIG. 7, in some examples, the fourth distance d1 is smaller than the first distance D1, and the fourth distance d1 is smaller than the third distance D3. For example, the center thickness of the second lens 120 is smaller than the center thickness of the first lens 110, and the center thickness of the second lens 120 is smaller than the center thickness of the fourth lens 140. For example, among the lenses of the lens component 100, the center thickness of the second lens 120 is the smallest.

Referring to FIG. 1 to FIG. 7, in some examples, a ratio of the fourth distance d1 to the effective focal length is 0.1 to 0.2. For example, a ratio of the center thickness of the second lens 120 to the effective focal length is 0.1 to 0.2. For example, the ratio of the fourth distance d1 to the effective focal length may be, but is not limited thereto, 0.1, 0.11, 0.12, 0.13, 0.14, 0.15, 0.16, 0.17, 0.18, 0.19, 0.2.

Referring to FIG. 1 to FIG. 7, in some examples, a ratio of the fifth distance d2 to the effective focal length is 0.3 to 0.5. For example, a ratio of the center thickness of the third lens 130 to the effective focal length is 0.3 to 0.5. For example, the ratio of the fourth distance d1 to the effective focal length may be, but is not limited thereto, 0.3, 0.32, 0.34, 0.36, 0.38, 0.4, 0.42, 0.44, 0.46, 0.48, 0.5.

Referring to FIG. 1 to FIG. 7, for example, the thickness of the fourth lens 140 should be as thin as possible based on the consideration of the surface type and the control of overall thickness of the optical system. For example, a ratio of the center thickness of the first lens 110 to the center thickness of the fourth lens 140 is greater than 1, that is, a ratio of the first distance D1 to the third distance D3 is greater than 1, which is, for example, 3:2.

Referring to FIG. 1 to FIG. 7, in some examples, a ratio of a center thickness to an edge thickness of the first lens 110 is greater than 1 and smaller than 3. For example, the ratio of the center thickness to the edge thickness of the first lens 110 may be, but is not limited thereto, 1, 1.5, 2, 2.5, 3.

Referring to FIG. 1 to FIG. 7, in some examples, a ratio of a center thickness to an edge thickness of the second lens 120 is greater than 0.5 and smaller than 1. For example, the ratio of the center thickness to the edge thickness of the second lens 120 may be, but is not limited thereto, 0.5, 0.6, 0.7, 0.8, 0.9, 1.

Referring to FIG. 1 to FIG. 7, in some examples, a ratio of a center thickness to an edge thickness of the third lens 130 is greater than 1 and smaller than 3. For example, the ratio of the center thickness to the edge thickness of the third lens 130 may be, but is not limited thereto, 1, 1.5, 2, 2.5, 3.

Referring to FIG. 1 to FIG. 7, in some examples, a ratio of a center thickness to an edge thickness of the fourth lens 140 is greater than 0.5 and smaller than 1. For example, the ratio of the center thickness to the edge thickness of the fourth lens 140 may be, but is not limited thereto, 0.5, 0.6, 0.7, 0.8, 0.9, 1.

In this way, by setting the ratio relationship between the center thickness and the edge thickness of each of the above-described lenses, it is favorable for ensuring injection molding of each lens.

Referring to FIG. 1 to FIG. 7, in some examples, the second lens 120, the third lens 130 and the fourth lens 140 are made of a same material, and a material of the first lens 110 is different from that the material of the second lens 120. For example, the refractive index of each lens may be 1.45 to 1.8, and the Abbe number may range from 25 to 60. For example, the second lens 120, the third lens 130 and the fourth lens 140 are made of the same material, and the material of the first lens 110 is different from the material of the second lens 120, which is favorable for correcting chromatic aberration. It should be noted that when the material of the first lens 110 is different from the material of the other three lenses, the surface type parameters may be adjusted adaptively, which is not limited by the present disclosure. For example, the refractive index of the first lens 110 is 1.59, and the refractive indices of the second lens 120, the third lens 130 and the fourth lens 140 are 1.54. By using different optical materials for the first lens 110 than other lenses, in combination with the air gap g between the first lens 110 and the second lens 120, it is favorable for improving the axial chromatic aberration and lateral chromatic aberration of the optical system. For example, when the material of the first lens 110 is different from that of the other lenses, a combination of a high dispersion material and a low dispersion material may be adopted. For example, an overall focal power of the second lens 120 and the third lens 130 is greater than a focal power of the first lens 110, and the first lens 110 may be made of a material with a low Abbe number, for example, the Abbe number is no greater than 31. For example, the Abbe number of the first lens 110 is 30.7. Meanwhile, the second lens 120, the third lens 130 and the fourth lens 140 may be made of a material with a high Abbe number, for example, the Abbe number is greater than 50. For example, the Abbe numbers of the second lens 120, the third lens 130 and the fourth lens 140 may be 50, 52, 55, 57, 60.

Referring to FIG. 1 to FIG. 7, for example, the first lens 110, the second lens 120, the third lens 130 and the fourth lens 140 may be made of the same optical material, which is convenient for fabricating the optical system. For example, when each lens in the lens component 100 is made of the same material, a low dispersion material with a high refractive index may be adopted, for example, the refractive index is greater than 1.5, for example, the Abbe number is greater than 50. For example, the second lens 120 and the third lens 130 may also adopt the same or different optical materials. For example, the third lens 130 and the fourth lens 140 may also adopt the same or different optical materials. For example, the second lens 120 and the fourth lens 140 may also adopt the same or different optical materials.

Referring to FIG. 1 to FIG. 7, for example, when the first lens 110, the second lens 120, the third lens 130 and the fourth lens 140 are of the same optical material, optical characteristics such as spectral transmissivity, refractive index, Abbe number and etc. may be considered, and processability such as material fluidity, thermal shrinkage, stress, cost and etc. may also be considered. For example, materials like optical grade polymethylmethacrylate (PMMA), polycarbonate (PC), cycloolefin copolymer (COC), cycloolefin homopolymer (COP), polyethylene terephthalate (PET) may be adopted.

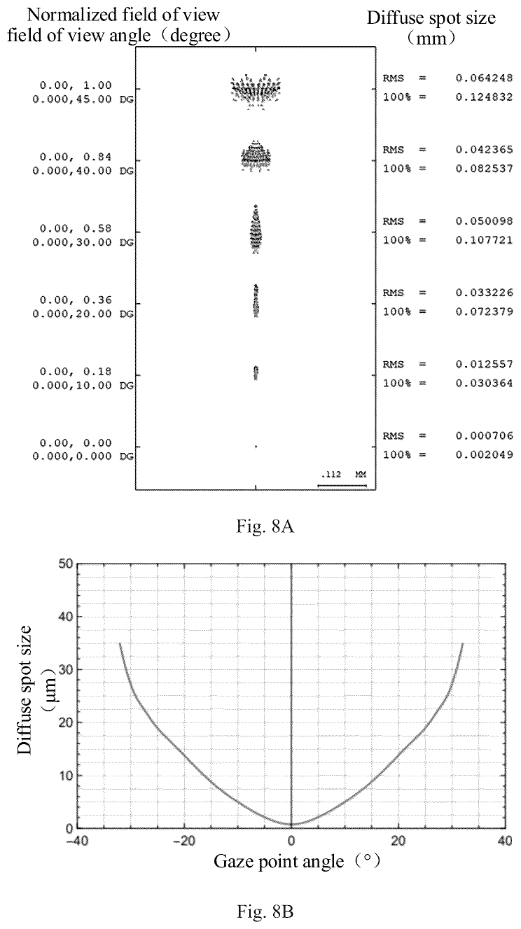

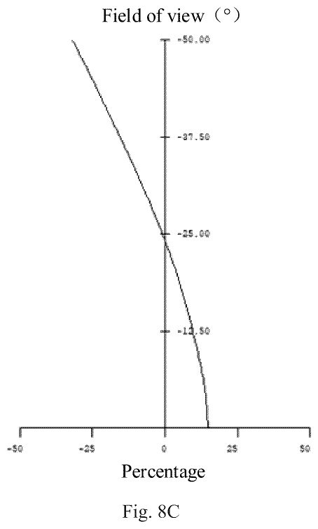

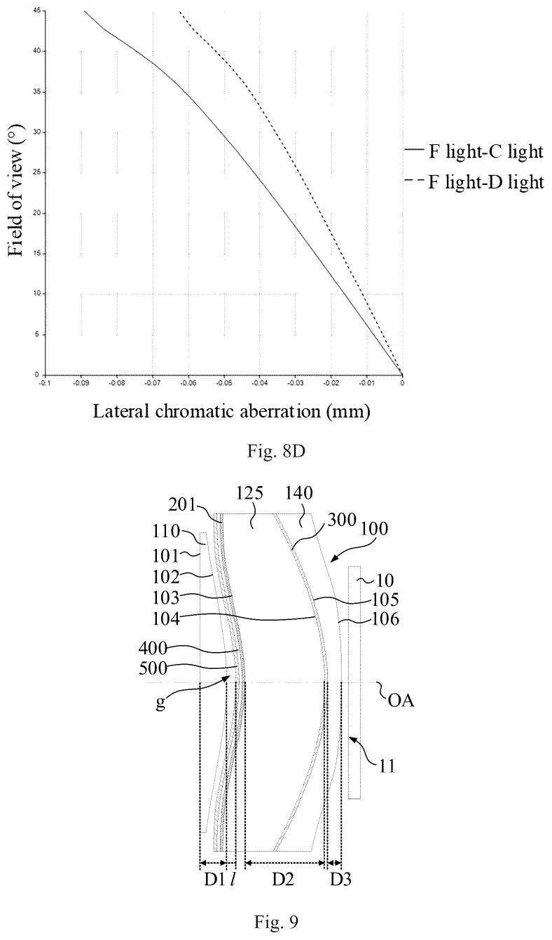

In combination with the foregoing examples, FIG. 8A is a spot diagram of the optical system shown in FIG. 4. FIG. 8B is a curve chart of a diffuse spot size of the optical system shown in FIG. 4 changing with field of view.

Referring to FIG. 8A, a spot diagram refers to a diffused graph formed by spots distributed in a certain range, in which the spots are intersection points of many rays emitted from a single point passing through an optical system with an image plane that are no longer concentrated at a same point because of aberration; and the spot diagram may be used to evaluate imaging quality of an optical system. In FIG. 8A, taking a first set of values in the left longitudinal direction as an example, 0.00 represents a normalized field of view in the X direction, 1.00 represents a normalized field of view in the Y direction, 0.000 represents a field of view in the X direction, and 45.00 represents a field of view in the Y direction. In FIG. 8A, taking a first set of values in the right longitudinal direction as an example, RMS represents a root mean square of the radius from a diffusion point of a diffuse spot to a mass center of the diffuse spot (or a center of the diffuse spot), and 100% represents the diameter of the diffuse spot. FIG. 8A is usually used to evaluate the full field of view clarity of the optical system, that is, imaging clarity of the full field of view that may be covered by residual light when a human eye pupil is located at an entrance pupil position on an optical axis and is gazed on a center of a lens (i.e., a zero field of view), which is also referred to as a transient mode. Besides considering the full field of view clarity in the transient mode, gaze point clarity is one of the more important optical indicators for the wearers wearing a head-mounted display, for example. The gaze point clarity refers to the clarity of an image within a certain angular range that may be directly seen (rather than being seen by residual sight) when the eye rotates up, down, left and right.

In the gaze point mode, the eye rotates a certain angle, and the pupil deviates from the center of the optical axis, causing certain deviation from the Z direction and the Y direction of the optical axis, and a certain included angle between a main ray passing through the center of the pupil and the Z axis. For example, a range of the included angle is set at ±35 degrees, the range of the included angle takes into account the observation habits of the human eye; in the case where a person wants to see an object in front of the person more than 35 degrees beyond the center of the eye, the person will actively turn the head of the person instead of laboriously rotating the eyeball of the person. Referring to FIG. 8B which shows a relationship between gaze point clarity and a gaze point angle, a diffuse spot in the central field of view is much smaller than one pixel, and the diameter of the diffuse spot is smaller than 20 m when the human eye rotates to 25 degrees. As can be seen from FIG. 8B, the diffuse spots of the optical system of the present application is relatively small, and the resolution of the optical system is relatively high. To sum up, the optical system provided by at least one embodiment of the present disclosure can produce clear images.

FIG. 8C shows a distortion diagram of the optical system shown in FIG. 4. Referring to FIG. 8C, the distortion diagram reflects the difference of image plane positions in which different fields of view form clear images; as shown in FIG. 8C, the absolute value of the maximum distortion is within 50%. Therefore, the optical system provided by at least one embodiment of the present disclosure can better correct distortion and meet the requirements of high-quality imaging. Additionally, distortion correction may be preprocessed in software.

FIG. 8D is a lateral chromatic aberration diagram of the optical system shown in FIG. 4. Referring to FIG. 8D, the lateral chromatic aberration diagram shows the height difference of each wavelength relative to the central wavelength at different image heights on the imaging plane, the horizontal axis represents the lateral chromatic aberration value of each wavelength relative to the central wavelength, and the vertical axis represents the normalized field of view. As shown in FIG. 8D, F light is cyan light, C light is red light, D light is yellow light, C light and F light are located at two ends of the sensitive area of the human eye, and D light is located close to the most sensitive spectral line of the human eye. As can be seen from the figure, the absolute value of the lateral chromatic aberration of F light and C light is controlled within 0.1 mm, and the absolute value of the lateral chromatic aberration of F light and D light is controlled within 0.1 mm, meaning that the optical system can effectively correct chromatic aberration of the edge of the field of view as well as secondary spectrum of the whole image plane.

Referring to FIG. 1 to FIG. 7, in some examples, the polarized reflection layer 200 is configured to reflect linearly polarized light of one characteristic and transmit linearly polarized light of another characteristic, the polarized reflection layer 200 is disposed on a side of the third surface 103 that is away from the fourth surface 104, and the phase retardation film 400 is disposed between the polarized reflection layer 200 and the transflective film 300. For example, the polarized reflection layer 200 may also be referred to a polarized beam-splitting film. For example, the polarized reflection layer may include a dual brightness enhancement film (DBEF). For example, the polarized reflection layer may also include an advanced polarizer film (APF). For example, the polarized reflection layer may further include an image quality polarizer standard (IQPS) film or an image quality polarizer enhanced (IQPE) film. For example, the above-described polarized reflection layer 200 capable of reflecting linearly polarized light of one characteristic and transmitting linearly polarized light of another characteristic, the phase retardation film 400 and the transflective film 300 form a folded optical path.

FIG. 9 is a partial cross-sectional view of a display apparatus provided by an example of an embodiment of the present disclosure. The optical system shown in FIG. 9 differs from the optical system shown in FIG. 1 in that the phase retardation film in the optical system shown in FIG. 9 differs from the phase retardation film in the optical system shown in FIG. 1, and the positional relationship between the film layers is different. Of course, there may be other differences between the optical system shown in FIG. 3 and the optical system shown in FIG. 1, such as the number of lenses in the lens component, the surface type of each lens, etc., which is not limited by the present disclosure.

It should be noted that the lens component in the optical system shown in FIG. 9 may be different from or the same as the lens component in the optical system shown in FIG. 1. The polarized reflection layer 200, the transflective film 300 and the linear polarizer film 500 in the optical system shown in FIG. 9 may have the same characteristics as the polarized reflection layer 200, the transflective film 300 and the phase retardation film 400 in the optical system shown in FIG. 1, which will not be repeated here.

Referring to FIG. 9, in some examples, the polarized reflection layer is a cholesteric liquid crystal layer 201, the cholesteric liquid crystal layer 201 is disposed on a side of the third surface 103 that is away from the fourth surface 104, and the phase retardation film 400 is disposed on a side of the cholesteric liquid crystal layer 201 that is away from the transflective film 300. For example, cholesteric liquid crystals may reflect circularly polarized light and transmit circularly polarized light. Referring to the folded optical path principle as mentioned above, the cholesteric liquid crystal layer 201 is provided between the phase retardation film 400 and the transflective film 300. The display surface 11 of the display screen 10 located on a side of the fourth lens 140 that is away from the first lens 110 may be provided with a wave plate; image light emitted from the display screen 10 is converted into right-handed circularly polarized light after passing through the wave plate; the right-handed circularly polarized light is incident to the transflective film 300; and the right-handed circularly polarized light keeps a polarized state unchanged after passing through the transflective film 300. The right-handed circularly polarized light is reflected back to the transflective film 300 after passing through the cholesteric liquid crystal layer 201, where a first reflection occurs; the right-handed circularly polarized light is reflected at the transflective film 300, where a second reflection occurs. Because of half wave loss, the reflected light changes from right-handed circularly polarized light to left-handed circularly polarized light; the left-handed circularly polarized light is transmitted by the cholesteric liquid crystal layer 201, then reaches the phase retardation film 400, and is converted into s-polarized light by the phase retardation film 400; then, the s-linearly polarized light is transmitted by the linear polarization film 500 and is exited towards the human eye.

Referring to FIG. 1 to FIG. 9, for example, a ratio of an effective aperture of the lens component 100 to the effective focal length is 2.2 to 2.7. The above-described effective aperture of the lens component 100 refers to an effective clear aperture, for example, a maximum aperture allowing light to pass through the lens component 100, and the aperture is determined by a maximum luminous flux of the lens component 100. For example, the ratio of the effective aperture to the effective focal length is 1 to 1.3.

Referring to FIG. 1 to FIG. 9, for example, a ratio of a total track length (TTL) to the effective focal length of the optical system is 0.9 to 1.1. Total track length refers to a distance between the highest point on the first surface 101 of the lens component 100 in the optical system and the center of the display screen 10 along the optical axis OA. The highest point on the first surface 101 includes an edge sagittal height of the lens component 100 that is on the first surface 101 side. The ratio of TTL to the effective focal length may be, but is not limited thereto, 0.9, 0.95, 1, 1.05, 1.1.

Referring to FIG. 1 to FIG. 9, for example, the field of view of the optical system 100 is greater than 90 degrees. For example, the field of view is the full field of view. For example, the field of view of the optical system may be, but is not limited thereto, 90 degrees, 92 degrees, 94 degrees, 96 degrees, 98 degrees, 100 degrees. For example, by calculating with the effective aperture capable of achieving a field of view of 100 degrees, the weight of binocular lenses is approximately is about 35 g.

Referring to FIG. 1 to FIG. 9, for example, a ratio of a distance between a diaphragm (such as human eye) and the first surface 101 in the optical axis OA to the effective focal length in the optical system is 1. For example, an effective aperture of the diaphragm is 4 mm. For example, a ratio of a distance between an object plane and the diaphragm in the optical axis OA to the effective focal length in the optical system is below 100. For example, a ratio of a distance between an image plane and the sixth surface 106 in the optical axis OA to the effective focal length in the optical system is 0.2. For example, a ratio of an effective aperture of the image plane to the effective focal length is 0.75 to 2. For example, the ratio of the effective aperture of the image plane to the effective focal length may be, but is not limited thereto, 0.75, 0.8, 0.85, 0.9, 0.95, 1, 1.2, 1.4, 1.6, 1.8, 2.

Referring to FIG. 9, at least one embodiment of the present disclosure provides a display apparatus, which includes a display screen 10 and an optical system in any of the above-described embodiments; the display screen 10 is located on a side of the sixth surface 106 that is away from the first surface 101. Since the display apparatus according to the embodiment of the present disclosure includes at least one of the above optical systems, it also has corresponding beneficial effects, which will not be repeated here. It can be understood that the display screen 10 shown in FIG. 9, when combined with the above-described optical systems shown in FIG. 1 to FIG. 7, can form different display apparatuses.

For example, a display surface 11 of the display screen 10 is located on a focal plane of a light incident side of the optical system.

For example, the display screen 10 may be any type of display screen, such as a liquid crystal display screen, an organic light emitting diode display screen, an inorganic light emitting diode display screen, a quantum dot display screen, a projector (e.g., an LCOS mini projector), etc.

For example, the display screen 10 is a liquid crystal display screen, and the pixel size is twenty-something micrometers. For example, the display screen 10 is an organic light emitting diode display screen, and the pixel size is a few micrometers.

For example, the display apparatus may be a virtual reality display apparatus. For example, the virtual reality display apparatus may be a display apparatus that adopts ultra-short focus folded optical path.

For example, the display apparatus may be a near-eye display apparatus, the near-eye display apparatus may be a wearable VR helmet, VR glasses, etc.; and the embodiment of the present disclosure is not limited thereto.

The following statements should be noted:
(1) In the accompanying drawings of the embodiments of the present disclosure, the drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. An optical system, comprising:
a lens component, comprising at least three lenses, the at least three lenses comprising a first surface, a second surface, a third surface, a fourth surface, a fifth surface and a sixth surface arranged sequentially along a direction of an optical axis of the lens component, and the fourth surface and the fifth surface having a same surface type parameter;
a polarized reflection layer, disposed on a side of the third surface that is away from the fourth surface;
a transflective film, disposed on a side of the fourth surface that is away from the third surface; and
a phase retardation film, disposed on a side of the transflective film facing the second surface;
wherein the second surface is a convex surface, the third surface is a concave surface, the fourth surface is a convex surface, the fifth surface is a concave surface and the sixth surface is a convex surface;
a distance between two intersection points where the first surface and the second surface intersect with the optical axis is a first distance, a distance between two intersection points where the third surface and the fourth surface intersect with the optical axis is a second distance, and a distance between two intersection points of the fifth surface and the sixth surface intersect with the optical axis is a third distance;
a ratio of an absolute value of a curvature radius of the fourth surface to an absolute value of a curvature radius of the third surface is 0.8 to 1, the second distance is greater than the first distance, and the second distance is greater than the third distance.

2. The optical system according to claim 1, wherein a ratio of the absolute value of the curvature radius of the third surface to an effective focal length of the optical system is 2 to 10, a conic constant of the third surface is −50 to 0, a ratio of the absolute value of the curvature radius of the fourth surface to the effective focal length of the optical system is 1.5 to 2.5, and a conic constant of the fourth surface is −10 to 2.

3. The optical system according to claim 1, wherein a ratio of the first distance to an effective focal length of the optical system is 0.1 to 0.3;
a ratio of the second distance to the effective focal length is 0.4 to 0.7;
a ratio of the third distance to the effective focal length is 0.1 to 0.2.

4. The optical system according to claim 1, wherein an air gap is provided between the second surface and the third surface.

5. The optical system according to claim 4, wherein an absolute value of a size of the air gap in the optical axis is 0.5 mm to 1 mm.

6. The optical system according to claim 1, wherein a ratio of an absolute value of a curvature radius of the second surface to an effective focal length of the optical system is 2 to 10, and a conic constant of the second surface is −50 to 0.

7. The optical system according to claim 1, wherein at least one selected from the group consisting of the second surface, the third surface and the fourth surface is an aspherical surface or a freeform surface.

8. The optical system according to claim 1, further comprising a linear polarizer film,
wherein the linear polarizer film is disposed on a side of the polarized reflection layer that is away from the transflective film.

9. The optical system according to claim 8, wherein the linear polarizer film is disposed on one of the first surface, the second surface and the third surface.

10. The optical system according to claim 1, wherein the lens component comprises a first lens, a second lens, a third lens and a fourth lens arranged along the direction of the optical axis, the first lens comprises the first surface and the second surface, the second lens comprises the third surface, the third lens comprises the fourth surface, the second lens further comprises a seventh surface opposite to the third surface, the third lens further comprises an eighth surface between the fourth surface and the seventh surface, the fourth lens comprises the fifth surface and the sixth surface;
the seventh surface and the eighth surface are both flat surfaces, or the seventh surface and the eighth surface have a same surface type parameter, the absolute value of the curvature radius of the third surface and the absolute value of the curvature radius of the fourth surface are both smaller than an absolute value of a curvature radius in at least one direction of the seventh surface;
the phase retardation film is located between the seventh surface and the eighth surface.

11. The optical system according to claim 10, wherein a distance between two intersection points of the seventh surface and the third surface intersect with the optical axis is a fourth distance, a distance between two intersection points of the eighth surface and the fourth surface intersect with the optical axis is a fifth distance;
the fourth distance is smaller than the fifth distance.

12. The optical system according to claim 11, wherein a ratio of the first distance to the fourth distance is 1 to 2;
a ratio of the third distance to the fourth distance is 0.75 to 1.5;
a ratio of the fifth distance to the fourth distance is 1.75 to 3.

13. The optical system according to claim 11, wherein the fourth distance is smaller than the first distance, and the fourth distance is smaller than the third distance.

14. The optical system according to claim 11, wherein a ratio of the fourth distance to an effective focal length of the optical system is 0.1 to 0.2;
a ratio of the fifth distance to the effective focal length is 0.3 to 0.5.

15. The optical system according to claim 10, wherein a ratio of a center thickness to an edge thickness of the first lens is greater than 1 and smaller than 3;
a ratio of a center thickness to an edge thickness of the second lens is greater than 0.5 and smaller than 1;
a ratio of a center thickness to an edge thickness of the third lens is greater than 1 and smaller than 3;
a ratio of a center thickness to an edge thickness of the fourth lens is greater than 0.5 and smaller than 1.

16. The optical system according to claim 10, wherein an absolute value of a curvature radius in the at least one direction of the seventh surface is 100 millimeters to 200 millimeters.

17. The optical system according to claim 10, wherein the second lens, the third lens and the fourth lens are made of a same material, and a material of the first lens is different from the material of the second lens.

18. The optical system according to claim 1, wherein the first surface is a flat surface; or
the first surface is a curved surface, and a ratio of an absolute value of a curvature radius of the first surface to an effective focal length of the optical system is greater than or equal to 20.

19. The optical system according to claim 1, wherein the polarized reflection layer is configured to reflect linearly polarized light of one characteristic and transmit linearly polarized light of another characteristic, the polarized reflection layer is disposed on a side of the third surface that is away from the fourth surface, and the phase retardation film is disposed between the polarized reflection layer and the transflective film; or
the polarized reflection layer is a cholesteric liquid crystal layer, the cholesteric liquid crystal layer is disposed on a side of the third surface that is away from the fourth surface, and the phase retardation film is disposed on a side of the cholesteric liquid crystal layer that is away from the transflective film.

20. A display apparatus, comprising a display screen and the optical system according to claim 1, wherein the display screen is located on a side of the sixth surface that is away from the first surface.
